(19) United States
(12) Patent Application Publication
(10) Pub. No.: US 2002/0158915 A1
(43) Pub. Date: Oct. 31, 2002

(54) Device interface with function keys and color coded soft key labels

(76) Inventors: Joseph Rowell JR., Santa Rosa, CA (US); Dennis John McCarthy, Glen Ellen, CA (US); Donald Wilson Stark, Santa Rosa, CA (US)

Correspondence Address: AGILENT TECHNOLOGIES, Legal Department, 51U-PD, Intellectual Property Administration, P.O. Box 58043, Santa Clara, CA, 95052-8043, US

(21) Appl. No.: 09/796,160

(22) Filed: Feb. 28, 2001

(51) Int. Cl. G06F 3/00

(52) U.S. Cl. 345/835; 345/840

(57) ABSTRACT

An interface for an electronic device includes a plurality of function keys. Each function key has a distinct color different from other function keys in the plurality of function keys. The electronic instrument also includes a display. The display displays a plurality of soft key labels. Each soft key label is associated with and has a same color as one function key from the plurality of function keys. Coloring indicates to a viewer of the display associations between soft key labels and function keys.

### BACKGROUND

The present invention concerns interfaces to electronic devices and pertains particularly to a device interface with function keys and color coded soft key labels.

Many electronic devices such as computers, personal digital assistants, electronic instruments, calculators and so on, use hard keys for input. The hard keys can be alphanumeric keys such as those found on a keyboard. In addition, some hard keys act as function keys that have different functions assigned to them.

For ease of use by a user, often a row of function keys will be placed adjacent to a display on which is displayed an image of the function keys. For each function key an immediately adjacent image of the function key includes a label indicating a current function of the adjacent function key. This use of function keys with adjacent labels is often referred to as “soft keys”. While allowing versatile notification to a user of the currently assigned function to function keys, soft keys have the disadvantage of requiring a row of keys immediately adjacent to corresponding function keys.

Besides the use of hard keys, there are many other ways for users to interface with electronic devices. For example, when an electronic device uses dialog boxes, point and select devices and/or key selections can be utilized by a user to communicate with the electronic device.

### SUMMARY OF THE INVENTION

In accordance with the preferred embodiment of the present invention, an interface for an electronic device includes a plurality of function keys. Each function key has a distinct color different from other function keys in the plurality of function keys. The electronic instrument also includes a display. The display displays a plurality of soft key labels. Each soft key label is associated with and has a same color as one function key from the plurality of function keys. Coloring indicates to a viewer of the display associations between soft key labels and function keys.

The present invention allows implementation of a simple, efficient and versatile user interface for an electronic device.

### BRIEF DESCRIPTION OF THE DRAWINGS

FIG. 1 is a simplified diagram of an instrument panel of an electronic instrument in accordance with a preferred embodiment of the present invention.

FIG. 2 shows additional detail of an image of a toolbar that is displayed on the instrument panel of the electronic instrument shown in FIG. 1, in accordance with a preferred embodiment of the present invention.

### DESCRIPTION OF THE PREFERRED EMBODIMENT

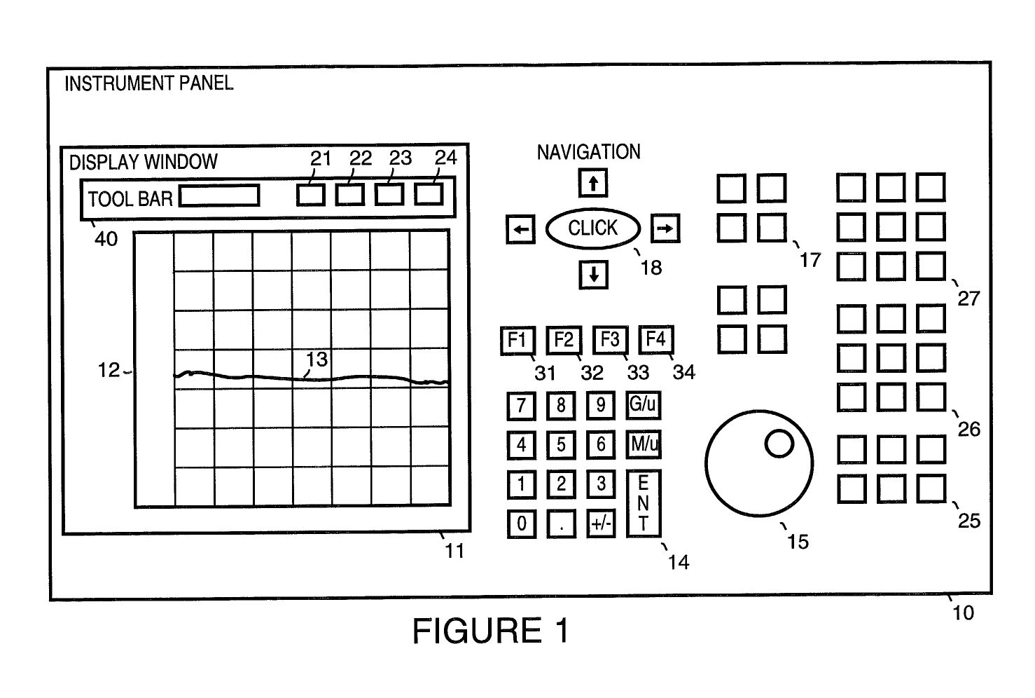

FIG. 1 is a simplified diagram of an instrument panel 10 of an electronic instrument. Instrument panel 10 includes a function key 31, a function key 32, a function key 33 and a function key 34. Each function key is a distinct color. For example, function key 31 is the color “happy sun yellow”. Function key 32 is the color “green with ivy”. Function key 33 is the color “big blue tsunami”. Function key 34 is the color “pink cause I wanna be”.

Instrument panel 10 also includes a display 11. Display 11 is currently displaying a trace 13 on a graph 12.

Display 11 also is shown displaying toolbar 40 that includes a soft key label 21, a soft key label 22, a soft key label 23 and a soft key label 24. Soft key labels 21, 22, 23 and 24 are color coded to correspond to function keys 31, 32, 33 and 34, respectively. For example, soft key label 21 is displayed using the color yellow. Soft key label 22 is displayed using the color green. Soft key label 23 is displayed using the color blue. Soft key label 24 is displayed using the color magenta.

Instrument panel 10 also includes a navigation tool 18 consisting of hard keys. Navigation tool 18 can be utilized by a user as a point and select interface.

Instrument panel 10 additionally includes a numeric key pad 14 and a knob 15. Display hard keys 17 include a “Trace” key, a “Window” key, a “Measure/Setups” key and an “Arrange windows” key. Control hard keys 16 include an “OK” key, a “help” key, a “Cancel” key and a “Menu/Dialog” key.

Channel setup hard keys 27 include a “Start/Center” key, a Stop/'Span” key, a “Power” key, a “Sweep Setup” key, a “Channel” key, a “Sweep Type” key, a “Trigger” key, an “Average” key and a “Calibrate” key.

Trace setup hard keys 26 include a “Measure” key, a “Format” key, a “Scale” key, a “Marker” key, a “Marker Table” key, a “Limit Table” key, a “Marker Search” key, a “Marker Function” key and a “Math/Memory” key.

Utility keys 25 include a “Save” key, a “Maximize” key, a “Preset” key, a “Recall” key, a “Print” key and a “Macro” key.

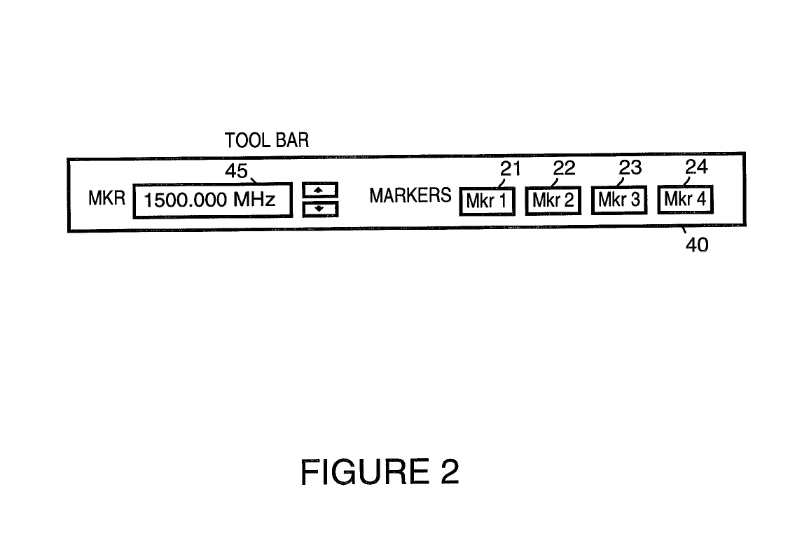

FIG. 2 shows additional detail of toolbar 40. In this more detailed image, toolbar 40 is shown to include various labeling and an entry box 45 that displays a value. Additionally, the text for each of soft key label 21, soft key label 22, soft key label 23 and soft key label 24 is shown. Toolbar 40 also includes entry control box 45 along with a label and up/down arrows.

As discussed above, the four soft key labels 21 through 24 within toolbar 40 correspond to, and have the same arrangement and colors as, the four function keys 31 through 34 of instrument panel 10. A user can easily associate the similarly colored and positioned pairs, even if they are physically distant from each other.

The text shown on each of soft key labels 21 through 24 indicates an instrument setting, a value to apply to a setting, an instrument function, or another operation associated with the selected function key 31 through 34. Pressing the similarly colored function key 31 through 34 initiates the behavior indicated by the text of the soft key label. The functions can also be selected by using a mouse or other pointing/selection device to “point-and-click” on the soft key label itself.

If a function key corresponding to a soft key label indicating the name of an instrument numeric setting is selected, the setting's current value appears in an entry box (e.g., entry control box 45) for the particular displayed format of toolbar 40. The value can then be changed with the instrument panel number pad 14 or knob 15 or by clicking on the up/down arrows adjacent to entry control box 45.

The format of Toolbar 40 depends upon which hard key is used to bring up toolbar 40. In the preferred embodiment, every format of toolbar 40 includes four function key labels and one or more entry boxes.

For example, Table 1 below indicates the text of soft key labels 21 through 24 that results from pressing any of the hard keys on instrument panel 10.

TABLE 1

| | Soft key | Soft key | Soft key | Soft key |
|---|---|---|---|---|
| | label 21 for | label 22 for | label 23 for | label 24 for |
| | F1 (31) | F2 (32) | F3 (33) | F4 (34) |
| Hard Key | (Color | (Color | (Color | (Color |
| Name | Yellow) | Green) | Blue) | Pink) |
| Trace | New | Next | | Delete |
| | | Trace | | |
| Window | New | Next | | Close |
| | | Window | | |
| Measure | Setup A | Setup B | Setup C | Setup D |
| Setups | | | | |
| Arrange | Overlay | Stack 2 | Split 3 | Quad 4 |
| Windows | | | | |
| Start/ | Start | Stop | Center | Span |
| Center | | | | |
| Stop/ | Start | Stop | Center | Span |
| Span | | | | |
| Power | Level | ON/off | Atten | Sweep |
| Channel | Ch 1 | Ch 2 | Ch 3 | Off |
| Trigger | Cont | Single | Hold | Restart |
| Sweep | Time | Points | BW | |
| Setup | | | | |
| Sweep | Linear | Pwr Swp | CW Time | Segment |
| Type | | | | |
| Avg | Avg # | Avg OFF | | Restart |
| Cal | Cal Wizard | Corr | Properties | Recall Cal |
| | | On/Off | | |
| Measure | S11 | S21 | S12 | S22 |
| Format | Log Mag | Smith | Phase | Delay |
| Scale | Autoscale | Scale | Ref Levl | Ref Pos |
| Marker | | | | |
| 1 of 3 | Mkr 1 | Mkr 2 | Mkr 3 | Off |
| 2 of 3 | Mkr 4 | Mkr 5 | Mkr 6 | Off |
| 3 of 3 | Mkr 7 | Mkr 8 | Mkr 9 | Off |
| Mkr Table | Show | | | Hide |
| Lim Table | Show | | | Hide |
| Mkr Srch | Max | Min | Left Pk | Right Pk |
| Mkr Func | >Center | >RefLev | >Delay | |
| MathMem | D >> Mem | D/Mem | Data | D & Mem |
| Save | Save As | AutoSave | | |
| Recall | File 1 | File 2 | File 3 | Open |
| Preset | | | | |
| Macro | User 1 | User 2 | User 3 | User 4 |

The foregoing discussion discloses and describes merely exemplary methods and embodiments of the present invention. As will be understood by those familiar with the art, the invention may be embodied in other specific forms without departing from the spirit or essential characteristics thereof. For example, the described embodiment sets out the use of four function keys with particular colors. As will be understood by persons skilled in the art, the number and color of function keys chosen are implementation details that can vary widely between embodiments of the present invention. Also, while an instrument panel application has been described, the invention can also apply to other applications such as computers, personal digital assistants, cell phones, pagers, and a wide variety of other electronic devices. Accordingly, the disclosure of the present invention is intended to be illustrative, but not limiting, of the scope of the invention, which is set forth in the following claims.

We claim:

1. An interface for an electronic device comprising:
a plurality of function keys, each function key having a distinct color different from other function keys in the plurality of function keys; and,
a display, the display displaying a plurality of soft key labels, each soft key label being associated with and having a same color as one function key from the plurality of function keys, wherein coloring indicates to a viewer of the display associations between soft key labels and function keys.

2. An interface for an electronic device as in claim 1 wherein the plurality of function keys are not situated adjacent to the plurality of soft key labels.

3. An interface for an electronic device as in claim 1 wherein the interface is an instrument panel.

4. An interface for an electronic device as in claim 3 wherein hard keys on the instrument panel are pressed to change functions represented by the plurality of function keys and to change text of the plurality of soft key labels.

5. An interface for an electronic device as in claim 1 wherein text of each soft key label identifies current function represented by an associated function key.

6. An interface for an electronic device as in claim 1 wherein the plurality of soft key labels is within a toolbar that also includes an entry box displaying a value.

7. A method for implementing an interface for an electronic device, the method comprising the following steps:
(a) providing a plurality of function keys, each function key having a distinct color different from other function keys in the plurality of function keys; and,
(b) displaying on a display a plurality of soft key labels, each soft key label being associated with and having a same color as one function key from the plurality of function keys, wherein coloring indicates to a viewer of the display associations between soft key labels and function keys.

8. A method as in claim 7 wherein in step (b) the soft key labels are displayed in a location that is not immediately adjacent to the plurality of function keys.

9. A method as in claim 7 wherein the interface is an instrument panel.

10. A method as in claim 9 additionally comprising the following step:
(c) pressing hard keys on the instrument panel to change functions represented by the plurality of function keys and to change text of the plurality of soft key labels.

11. A method as in claim 7 wherein in step (b) text of each soft key label identifies current function represented by an associated function key.

12. A method as in claim 7 wherein in step (b) the plurality of soft key labels is within a toolbar that also includes an entry box displaying a value.

13. A method for implementing an interface for an electronic device, the method comprising the following steps:
(a) displaying on a display a plurality of soft key labels, each soft key label being associated with and having a same color as one function key from the plurality of function keys, wherein each function key in the plurality of function keys has a distinct color different from other function keys in the plurality of function keys and coloring indicates to a viewer of the display associations between soft key labels and function keys; and,
(b) in response to a user command, changing functions represented by the plurality of function keys and changing text of the plurality of soft key labels.

14. A method as in claim 13 wherein in step (b) the soft key labels are displayed in a location that is not immediately adjacent to the plurality of function keys.

15. A method as in claim 13 wherein the interface is an instrument panel.

16. A method as in claim 13 wherein in step (b) text of each soft key label identifies current function represented by an associated function key.

17. A method as in claim 13 wherein in step (b) the plurality of soft key labels is within a toolbar that also includes an entry box displaying a value.
